(19) United States
(12) Patent Application Publication
(10) Pub. No.: US 2014/0143518 A1
(43) Pub. Date: May 22, 2014

(54) MEMORY SYSTEM AND METHOD FOR OPERATING THE SAME

(71) Applicant: Samsung Electronics Co., Ltd., Suwon-si (KR)

(72) Inventors: DONG-WOO KIM, Seoul (KR); Sang-Hwa Jin, Seongnam-si (KR); Sang-Jong Kim, Bansong-Dong (KR)

(73) Assignee: Samsung Electronics Co., Ltd., Suwon-si (KR)

(21) Appl. No.: 14/082,938

(22) Filed: Nov. 18, 2013

(30) Foreign Application Priority Data
Nov. 21, 2012 (KR) 10-2012-0132444

(51) Int. Cl. G06F 12/10

(52) U.S. Cl. CPC G06F 12/10
USPC 711/207; 711/206

(57) ABSTRACT

A memory system comprises a central processing unit. A memory management unit receives a virtual address from the central processing unit. The memory management unit converts the virtual address into a physical address. A main memory is assessed based on the physical address. The main memory stores data used the central processing unit. The main memory includes a first area including a non-volatile memory. First file data having a first characteristic is included in the first area of the main memory. The main memory includes a second area including a volatile memory. Second file data having a second characteristic different from the first characteristic is included in the second area of the main memory. A management table manages only the first area of the first and second areas of the main memory.

### CROSS-REFERENCE TO RELATED APPLICATION

This application claims priority under 35 U.S.C. §119 to Korean Patent Application No. 10-2012-0132444 filed on Nov. 21, 2012 in the Korean Intellectual Property Office, the disclosure of which is incorporated by reference herein in its entirety.

### TECHNICAL FIELD

Exemplary embodiments of the present inventive concept relate to memory systems and methods for operating the same.

### DISCUSSION OF THE RELATED ART

Dynamic random access memory (DRAM) is used as a main memory of computing systems, for example. A memory management scheme called paging or page swapping may be used that allows secondary storage to virtually function as part of the main memory. Memory systems with reduced swapping time may be used for better performance of computing systems.

### SUMMARY

According to an exemplary embodiment of the inventive concept, a memory system comprises a central processing unit. A memory management unit is configured to receive a virtual address from the central processing unit. The memory management unit is configured to convert the virtual address into a physical address. A main memory is configured to be accessed based on the physical address. The main memory is configured to store data used by the central processing unit. The main memory includes a first area including a non-volatile memory. First file data having a first characteristic is included in the first area of the main memory. The main memory includes a second area including a volatile memory. Second file data having a second characteristic different from the first characteristic is loaded into the second area of the main memory. A management table is configured to manage only the first area in the first and second areas of the main memory.

According to an exemplary embodiment of the inventive concept, a method for operating a memory system comprises providing a main memory. The main memory includes a first area including a non-volatile memory. First file data having a first characteristic is included in the first area of the main memory. The main memory includes a second area including a volatile memory. Second file data having a second characteristic different from the first characteristic is included in the second area of the main memory. A management table is provided. The management table is configured to manage only the first area of the first and second areas of the main memory. A page swap-out is performed on the first file data by changing a predetermined flag included in the management table without deleting the first file data included in the first area. The page swap-out is performed on the second file data by deleting the second file data included in the second area.

According to an exemplary embodiment of the inventive concept, a memory device a first area in which first file data having a first characteristic is loaded and a second area in which second file data having a second characteristic different from the first characteristic is loaded. Only the first area of the first and second areas is managed based on a management table.

### BRIEF DESCRIPTION OF THE DRAWINGS

The above and other features of the inventive concept will become more apparent by describing in detail exemplary embodiments thereof with reference to the attached drawings, in which:

FIG. 1 is a block diagram showing a configuration of a memory system in accordance with an exemplary embodiment of the inventive concept;

FIG. 2 is a diagram illustrating a configuration of a main memory of FIG. 1, according to an exemplary embodiment of the inventive concept;

FIG. 3 is a diagram illustrating a configuration of a management table of FIG. 1, according to an exemplary embodiment of the inventive concept;

FIGS. 4 to 6 are diagrams illustrating a method for operating a memory system in accordance with exemplary embodiments of the inventive concept;

FIG. 7 is a block diagram showing a configuration of a memory system in accordance with an exemplary embodiment of the inventive concept;

FIG. 8 is a block diagram showing a configuration of a computing system in which a memory system in accordance with exemplary embodiments of the inventive concept may be employed;

FIG. 9 is a block diagram showing a configuration of an electronic system in which a memory system in accordance with exemplary embodiments of the inventive concept may be employed; and

FIG. 10 is a diagram illustrating an example in which the electronic system of FIG. 9 is applied to a smart phone.

### DETAILED DESCRIPTION OF THE EMBODIMENTS

Hereinafter, exemplary embodiments of the inventive concept will be described in detail with reference to the accompanying drawings. The inventive concept may, however, be embodied in many different forms and should not be construed as being limited to the embodiments set forth herein.

It will be understood that when an element or layer is referred to as being “on,” “coupled to,” or “connected to” another element or layer, it can be directly on, coupled to or connected to the other element or layer or intervening elements or layers may be present. Like numbers may refer to like or similar elements throughout the specification and the drawings.

The use of the terms “a,” “an,” and “the” are intended to include the plural forms as well, unless the context clearly indicates otherwise.

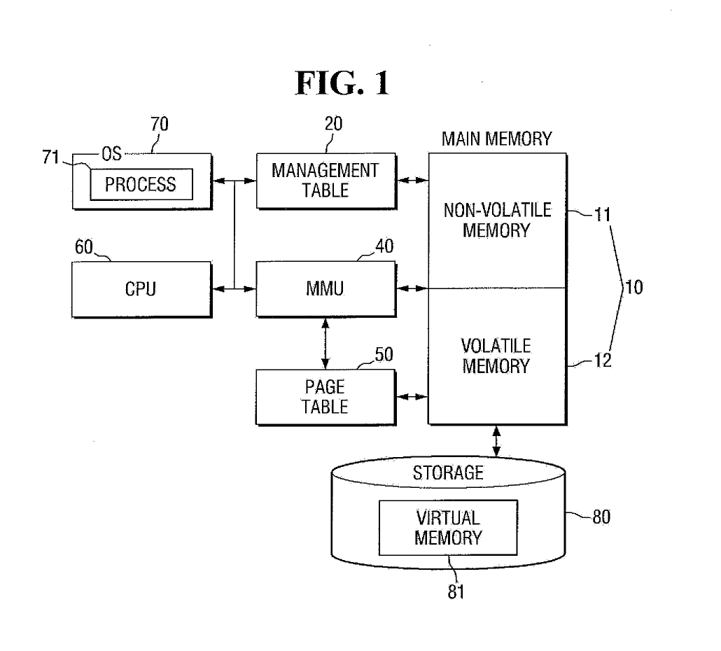

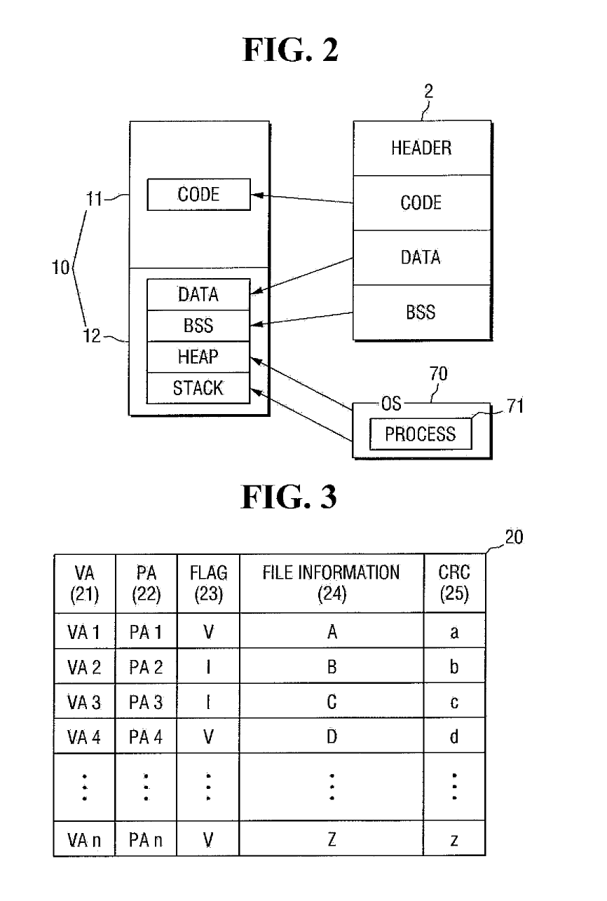

FIG. 1 is a block diagram showing a configuration of a memory system in accordance with an exemplary embodiment of the inventive concept. FIG. 2 is a diagram illustrating a configuration of a main memory of FIG. 1, according to an exemplary embodiment of the inventive concept. FIG. 3 is a diagram illustrating a configuration of a management table of FIG. 1, according to an exemplary embodiment of the inventive concept.

Referring to FIG. 1, the memory system includes a main memory 10, a management table 20, a memory management unit (MMU) 40, and a central processing unit (CPU) 60.

The main memory 10 may store data used by the central processing unit 60. The main memory 10 may include a first area 11 implemented by a non-volatile memory and a second area 12 implemented by a volatile memory. First file data having first characteristics is loaded into the first area 11 of the main memory 10. Second file data having second characteristics different from the first characteristics is loaded into the second area 12 of the main memory 10.

Referring to FIGS. 1 and 2, when the central processing unit 60 is operated by a process 71, a portion of file data 2 having read-only characteristics required for the operation of the process 71 may be loaded in the first area 11 of the main memory 10, and a portion of the file data 2 having read-write characteristics may be loaded in the second area 12 of the main memory 10. For example, when the central processing unit 60 is operated by the process 71, a code area of the file data 2 having read-only characteristics is loaded as first file data in the first area 11 of the main memory 10, and a HEAP, a STACK area assigned by an operating system (OS) 70, a Block Started by Symbol (BSS) area, and data of the file data 2 having read-write characteristics may be loaded as second file data in the second area 12 of the main memory 10.

Examples of a non-volatile memory implementing the first area 11 include a Magnetic Random Access Memory (MRAM), Phase-change Random Access Memory (PRAM), Ferroelectric Random Access Memory (FRAM) and the like, and examples of a volatile memory implementing the second area 12 include a Dynamic Random Access Memory (DRAM) and the like. For example, according to an exemplary embodiment of the inventive concept, the first area 11 of the main memory 10 may be implemented by a Magnetic Random Access Memory (MRAM), and the second area 12 of the main memory 10 may be implemented by a Dynamic Random Access Memory (DRAM), Static Random Access Memory (SRAM), or Embedded RAM.

When a storage space of the main memory 10 is divided into the first area 11 implemented by a non-volatile memory (e.g., MRAM) and the second area 12 implemented by a volatile memory (e.g., DRAM), and first file data having a first characteristic and second file data having a second characteristic different from the first characteristic are loaded in the areas 11 and 12, respectively, a page swap time can be minimized, thus achieving a high-speed operation.

The management table 20 may separately manage only the first area 11 of the main memory 10. For example, referring to FIGS. 1 and 3, the management table 20 may include a virtual address 21, a physical address 22, a flag 23, and additional information 24 and 25. The virtual address 21 is provided for each page and is matched with the physical address 22 in the main memory 10. Through the flag 23, whether first file data loaded in the first area 11 of the main memory 10 is valid data may be determined. Through the additional information 24 and 25, whether the first file data loaded in the first area 11 of the main memory 10 is the same data as the data stored in storage 80 may be determined.

In the memory system according to an exemplary embodiment of the inventive concept, a page swap-out is performed by changing the flag 23 included in the management table 20 without deleting the first file data loaded in the first area 11 of the main memory 10. Therefore, when the flag 23 included in the management table 20 is valid (V), it means that data is loaded in the first area 11 of the main memory 10 and the memory management unit 40 can refer to the data through a page table 50. When the flag 23 included in the management table 20 is invalid (I), this means that data remains in the first area 11 of the main memory 10 but the memory management unit 40 cannot refer to the data through the page table 50.

The additional information 24 and 25 may include file information 24 and a cyclic, redundancy check (CRC) value 25. For example, the file information 24 may contain the file storage time, file size and the like. The CRC value 25 may include a CRC value of the first file data loaded in the first area 11 of the main memory 10. Although only the file information 24 and the CRC value 25 have been illustrated as examples of the additional information 24 and 25 in FIG. 3, exemplary embodiments of the inventive concept are not limited thereto. Any information that may determine whether the first file data loaded in the first area 11 of the main memory 10 is the same data as the data stored in the storage 80 may be used as the additional information 24 and 25. For example, other information about the first file data loaded in the first area 11 of the main memory 10 and predetermined values calculated from the first file data loaded in the first area 11 may be included in the additional information 24 and 25 as long as the information and values may be used to determine whether the first file data loaded in the first area 11 of the main memory 10 is the same data as the data stored in the storage 80.

The management table 20 may be implemented in various ways depending on need. As an example, the management table 20 may be provided in a Transition Lookaside Buffer (TLB). As another example, the management table 20 may be managed directly by the OS 70. In the memory system according to an exemplary embodiment of the inventive concept, the method in which the management table 20 is implemented is not limited thereto.

Referring again to FIG. 1, the OS 70 may generate the process 71 that is used to execute the file data stored in the storage 80. The generated process 71 may instruct the central processing unit (CPU) 60 to calculate and process data addressed by a virtual address VA. Accordingly, the central processing unit 60 may provide a virtual address of data required for the calculation and processing to the memory management unit 40.

The memory management unit (MMU) 40 receives a virtual address from the central processing unit 60 and may convert the virtual address provided from the central processing unit 60 into a physical address PA that can be directly referred to in the main memory 10, e.g., by referring to the page table 50. For purposes of description, the page table 50 is separated from the main memory 10 in FIG. 1. However, exemplary embodiments of the inventive concept are not limited thereto. In an exemplary embodiment of the inventive concept, the page table 50 may be stored in the main memory 10.

The storage 80 may include a large storage space as compared with the main memory 10. The storage 80 may be formed of, e.g., a non-volatile memory, a Hard Disk Drive (HDD), a Solid State Driver (SSD) or the like, but exemplary embodiments of the inventive concept are not limited thereto.

In an exemplary embodiment of the inventive concept, a portion of the storage 80 may be used as a virtual memory 81. The virtual memory 81 may be used like the main memory 10. As the amount of data processed in the memory system is increased under a multi-media environment, when all of the data cannot be accommodated in the main memory 10, the virtual memory 81 may be used.

When the central processing unit 60 performs a calculation using the data stored in the virtual memory 81, the central processing unit 60 accesses the storage 80. Since access to the storage 80 is generally slower than access to the main memory 10, the central processing unit 60 may perform the calculation by loading the data stored in the virtual memory 81 into the main memory 10. Accordingly, in this case, page swapping between the virtual memory 81 and the main memory 10 may occur frequently, leading to the performance degradation of the entire system.

The memory system according to an exemplary embodiment of the inventive concept may increase system performance by reducing the number of times in which page swapping occurs between the virtual memory 81 and the main memory 10 and by decreasing the page swap time.

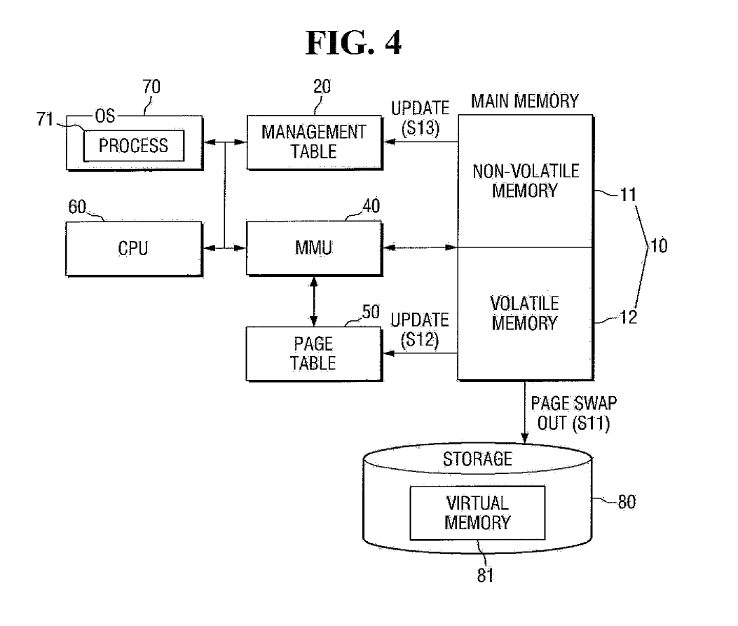

FIGS. 4 to 6 are diagrams illustrating a method for operating a memory system in accordance with exemplary embodiments of the inventive concept.

A page swap-out from the main memory 10 to the storage 80 (e.g., the virtual memory 81 of the storage 80) is described with reference to FIG. 4.

At least one of pages loaded in the main memory 10 is moved to the storage 80 is defined as a page swap-out, and at least one of pages stored in the storage 80 being moved to the main memory 10 is defined as a page swap-in.

A page swap-out from the main memory 10 to the storage 80 is performed (S11).

In this case, when first file data (e.g., code area) stored in the first area 11 of the main memory 10 is stored in the storage 80, the first file data remains in the first area 11. When second file data (e.g., stack area) loaded in the second area 12 of the main memory 10 is stored in the storage 80, the second file data is deleted from the second area 12, e.g., the management of the second file data is released with the second file data remaining in the second area 12, or other data is overwritten on the second file data. In other words, in an exemplary embodiment of the inventive concept, the first file data loaded in the first area 11 of the main memory 10 remains in the first area 11 of the main memory 10 even when the page swap-out is performed.

The page table 50 is updated based on the data changes that occur according to the page swap-out (S12).

When the page table 50 is updated, the memory management unit 40 cannot refer to the swapped-out pages by referring to the page table 50 unless the page table 50 is newly updated by the OS 70.

Then, the management table 20 is updated based on the data changes that occur according to the page swap-out for the first area 11 of the main memory 10 (S13).

For example, the flags 23 (see FIG. 3) for the pages which have undergone the page swap-out among the first file data loaded in the first area 11 of the main memory 10 are changed to invalid (I).

In other words, in the memory system according to an exemplary embodiment of the inventive concept, while performing the page swap-out on the first file data and the second file data respectively loaded in the first area 11 and the second area 12 of the main memory 10, the first file data remains loaded in the first area 11 and the flags 23 (see FIG. 3) included in the management table 20 are changed 11, and the second file data loaded in the second area 12 is deleted.

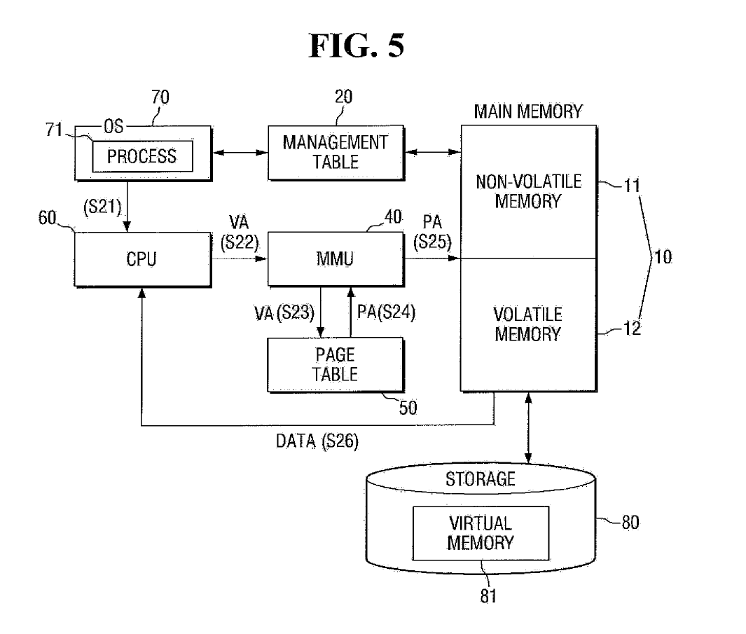

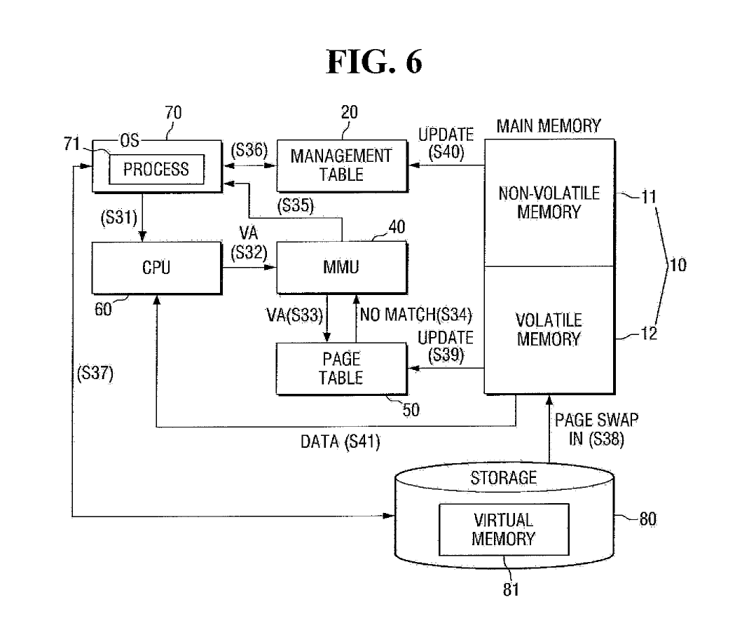

An operation in which the central processing unit 60 performs a calculation in response to a request of the process 71 is described with reference to FIGS. 5 and 6. In this case, when data requested by the central processing unit 60 is loaded in the main memory 10, a page swap-in from the storage 80 might not be performed. However, when the data requested by the central processing unit 60 is not loaded in the main memory 10, a page swap-in from the storage 80 may be performed.

Referring to FIG. 5, the OS 70 requests that the central processing unit 60 perform a calculation for executing the process 71 (S21). The central processing unit 60 transmits the virtual address VA of data for the calculation to the memory management unit 40 (S22).

The memory management unit 40 receives the virtual address VA from the central processing unit 60, refers to the page table 50 (S23), and obtains the physical address PA corresponding to the virtual address VA (S24). The memory management unit 40 searches the main memory 10 using the physical address PA (S25) and provides the data addressed by the physical address PA to the central processing unit 60 (S26). Accordingly, the central processing unit 60 performs the calculation for executing the process 71 using the provided data.

Referring to FIG. 6, the OS 70 requests that the central processing unit 60 perform the calculation for executing the process 71 (S31). Subsequently, the central processing unit 60 transmits the virtual address VA of data for the calculation to the memory management unit 40 (S32).

The memory management unit 40 receives the virtual address VA from the central processing unit 60 and refers to the page table 50 (S23). However, in this case, since the physical address PA corresponding to the virtual address VA provided from the central processing unit 60 is not included in the page table 50, the memory management unit 40 cannot obtain the physical address PA corresponding to the virtual address VA provided from the central processing unit 60 (S34). Accordingly, the memory management unit 40 generates, e.g., an interrupt, and notifies this to the OS 70 (S35).

In this case, when the first file data is not loaded in the first area 11 of the main memory 10, the OS 70 refers to the management table 20 (S36).

As a result of referring to the management table 20, when a corresponding page resides in the management table 20, but the flag 23 of the page is set to invalid (I), it is checked whether the page is in the same state as the data stored in the storage 80, for example, in the virtual memory 81 of the storage 80 (e.g., whether a file is loaded in the main memory 10 and then is not changed) using the additional information 24 and 25 of the corresponding page (S37). When the page remains in the same state, the page remaining in the main memory 10 during the page swap-out can be used as it is. Accordingly, the corresponding page is not loaded into the main memory 10 from the storage 80, and after the page table 50 and the management table 20 are updated (S39 and S40), the physical address 22 (see FIG. 3) of the corresponding page is returned. As a checking result, when the page does not remain in the same state, the page remaining in the main memory 10 during the page swap-out has been changed and thus cannot be used any longer. Accordingly, the corresponding page is loaded into the main memory 10 from the storage 80 (S38), and the page table 50 and the management table 20 are updated (S39 and S40).

As a result of referring to the management table 20, when the corresponding page does not exist in the management table 20, the corresponding page might not yet be loaded in the first area 11 of the main memory 10. Accordingly, the corresponding page is loaded in the first area 11 of the main memory 10 from the storage 80 (S37 and S38). Accordingly, the page table 50 is updated (S39), and the management table 20 is updated (S40).

In the memory system according to an exemplary embodiment of the inventive concept, since the first file data loaded in the first area 11 is not deleted during the page swap-out, the first area 11 can be filled with the first file data. In this case, a problem may occur when the page swap-in from the storage 80 is performed. In an exemplary embodiment of the inventive concept, the page swap-in may be performed after securing an empty storage space by deleting the oldest first file data that has been referred to in a Least Recent Used (LRU) manner However, this method is merely an example, and exemplary embodiments of the inventive concept are not limited thereto. According to an exemplary embodiment of the inventive concept, the page swap-in may be performed after securing an empty storage space by deleting the oldest first file data that has been loaded in a First In First Out (FIFO) manner.

Referring again to FIG. 6, when the second file data is not loaded into the second area 12 of the main memory 10, the OS 70 omits step S36 of referring to the management table 20 and loads a page into the second area 12 of the main memory 10 from the storage 80 (S37 and S38). The page table 50 is updated (S39), and the management table 20 is updated (S40).

Whether the first file data is not loaded into the first area 11 of the main memory 10 or the second file data is not loaded into the second area 12 of the main memory 10, the physical address PA corresponding to the page addressed by the virtual address VA may be known. Thus, the data loaded into the main memory 10 may be provided to the central processing unit 60 (S41). Accordingly, the central processing unit 60 performs a calculation for performing the process 71 using the provided data.

Thus, in the memory system according to an exemplary embodiment of the inventive concept, the main memory 10 is divided into the first area 11 implemented by, e.g., an MRAM, and the second area 12 implemented by, e.g., a DRAM, and the number of times in which the swapping operation of the pages loaded into the first area 11 is performed may be minimized. Therefore, a write operation of the MRAM may be conducted as infrequent as possible, thereby achieving a high-speed operation of the entire system.

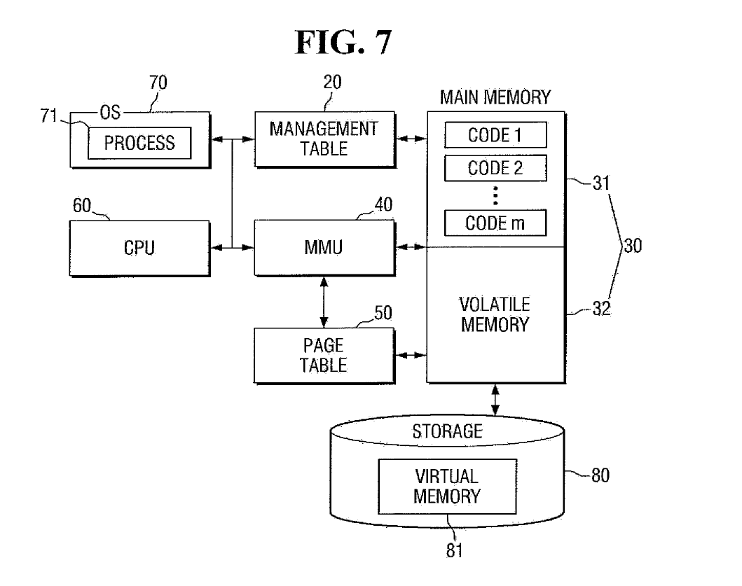

FIG. 7 is a block diagram showing a configuration of a memory system in accordance with an exemplary embodiment of the inventive concept.

Referring to FIG. 7, the memory system includes a main memory 30, the management table 20, the memory management unit 40, and the central processing unit 60.

The main memory 30 may store data used by the central processing unit 60. The main memory 10 may include a first area 31 implemented by a non-volatile memory and a second area 32 implemented by a volatile memory. First file data having first characteristics is loaded into the first area 31 of the main memory 10. Second file data having second characteristics different from the first characteristics is loaded into the second area 32 of the main memory 10.

In an exemplary embodiment of the inventive concept, during an initial operation of the memory system, a predetermined number m (m is a natural number) of pieces of the first file data among n pieces (n is a natural number) of the first file data stored in the storage 80 may be loaded into the first area 31 of the main memory 30. For example, during the initial operation of the memory system, according to an exemplary embodiment of the inventive concept, a predetermined number m of pieces of the first file data may be loaded in advance into the first area 31 of the main memory 30 regardless of whether the process 71 for execution has been created.

The m pieces of the first file data may be determined by allowing a user to select a frequently used program through an initial setup of the system or may be determined by the OS 70 by reflecting the situation in which the system is operated.

Thus, for example, when a predetermined number m of pieces of the first file data (e.g., code area) associated with the frequently used program are loaded in advance in the first area 31 of the main memory 30 during the initial start-up of the system, the number of times in which the page swap-in or page swap-out is performed can be further reduced, and the operation performance of the system can be further enhanced.

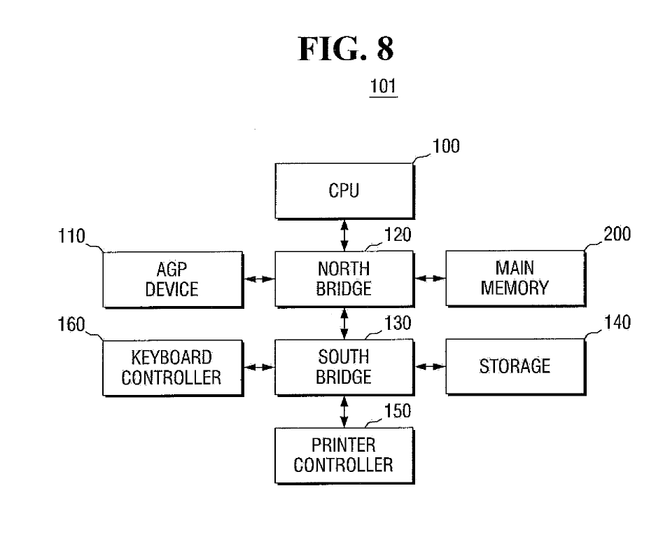

A computing system in which a memory system in accordance with an exemplary embodiment of the inventive concept may be employed will be described with reference to FIG. 8.

FIG. 8 is a block diagram showing a configuration of a computing system in which a memory system in accordance with an exemplary embodiment of the inventive concept may be employed.

Referring to FIG. 8, a computing system 101 includes a central processing unit (CPU) 100, an Accelerated Graphics Port (AGP) device 110, a main memory 200, a storage 140 (e.g., SSD, HDD, etc.), a north bridge 120, a south bridge 130, a keyboard controller 160, and a printer controller 150.

The computing system 101 may be a personal computer or laptop computer. However, exemplary embodiments of the inventive concept are not limited thereto.

In the computing system 101, the central processing unit 100, the AGP device 110 and the south bridge 130 may be connected to the north bridge 120. However, exemplary embodiments of the inventive concept are not limited thereto. For example, the north bridge 120 may be included in the central processing unit 100.

The AGP device 110 may have a bus that enables the fast implementation of three-dimensional graphic representation. The AGP device 110 may include a video card used to reproduce an image for a monitor.

The central processing unit 100 may perform various calculations used to operate the computing system 101 and may execute an operating system (OS) and application programs.

The main memory 200 may load and store data used to perform the operation of the central processing unit 100 from the storage 140. The main memory 200 according to an exemplary embodiment of the inventive concept may store data used by the central processing unit 100. The main memory 200 may include a first area (corresponding to the first area 11 of FIG. 1 or the first area 31 of FIG. 7) which is implemented by a non-volatile memory and a second area (corresponding to the second area 12 of FIG. 1 or the second area 32 of FIG. 7) which is implemented by a volatile memory. First file data (e.g., code area) having first characteristics stored in the storage 140 is loaded into the first area of the main memory 200. Second file data (e.g., data area or BSS area) having second characteristics different from the first characteristics stored in the storage 140 is loaded into the second area of the main memory 200.

Examples of a non-volatile memory implementing the first area (corresponding to the first area 11 of FIG. 1 or the first area 31 of FIG. 7) include a Magnetic Random Access Memory (MRAM), a Phase-change Random Access Memory (PRAM), a Ferroelectric Random Access Memory (FRAM) and the like, and examples of a volatile memory implementing the second area (corresponding to the second area 12 of FIG. 1 or the second area 32 of FIG. 7) include a Dynamic Random Access Memory (DRAM) and the like, but exemplary embodiments of the inventive concept are not limited thereto.

The storage 140, the keyboard controller 160, the printer controller 150, and various peripheral devices may be connected to the south bridge 130.

The storage 140 is a large-capacity data storage device for storing file data, and the storage 140 may be implemented by, e.g., an HDD or SSD, but exemplary embodiments of the inventive concept are not limited thereto.

In the computing system 101 according to an exemplary embodiment of the inventive concept, the storage 140 is connected to the south bridge 130. However, exemplary embodiments of the inventive concept are not limited thereto. For example, the storage 140 may be connected to the north bridge 120, or the storage 140 may be directly connected to the central processing unit 100.

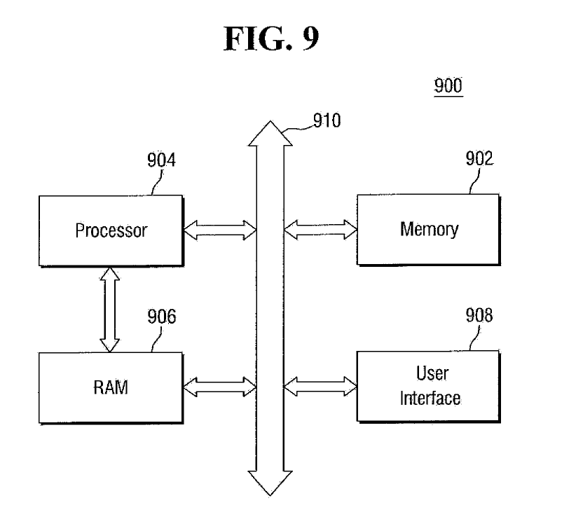

An electronic system in which a memory system in accordance with an exemplary embodiment of the inventive concept may be employed is described with reference to FIG. 9.

FIG. 9 is a block diagram showing a configuration of an electronic system in which a memory system in accordance with an exemplary embodiment of the inventive concept may be employed.

Referring to FIG. 9, an electronic system 900 may employ a memory system in accordance with an exemplary embodiment of the inventive concept. For example, the electronic system 900 may include a memory system 902, a processor 904, a RAM 906, and a user interface 908.

The memory system 902, the processor 904, the RAM 906, and the user interface 908 may perform data communication with each other using a bus 910.

The processor 904 may execute a program and may control the electronic system 900. The RAM 906 may be used as an operating memory of the processor 904. In this case, when the electronic system 900 employs a memory system in accordance with an exemplary embodiment of the inventive concept, the processor 904 may correspond to the central processing unit 60 of FIGS. 1 and 4 to 7, and the RAM 906 may correspond to the main memory 10 of FIG. 1 or the main memory 30 of FIG. 7. The processor 904 and the RAM 906 may be implemented as one semiconductor device, or the processor 904 and the RAM 906 may be packaged into a semiconductor package.

The user interface 908 may be used to input/output data into/from the electronic system 900. The memory system 902 may store codes for the operation of the processor 904, data processed by the processor 904, or data inputted from an external device. When the electronic system 900 employs a memory system in accordance with an exemplary embodiment of the inventive concept, the memory system 902 may correspond to the storage 80 of FIGS. 1 and 4 to 7.

The memory system 902 may include a separate controller for operating the memory system 902, and the memory system 902 may be configured to include an error correction block. The error correction block may be configured to detect and correct an error of the data stored in the memory system 902 using an error correction code (ECC).

The memory system 902 may be integrated into a single semiconductor device. For example, the memory system 902 may form a memory card. Examples of the memory card may include a personal computer card (PCMCIA, personal computer memory card international association), a compact flash card (CF), a smart media card (SM or SMC), a memory stick, a multimedia card (MMC, RS-MMC, MMCmicro), an SD card (SD, miniSD, microSD, SDHC), and a universal flash storage (UFS), but exemplary embodiments of the inventive concept are not limited thereto.

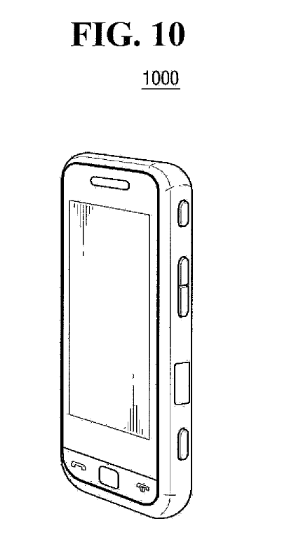

The electronic system 900 shown in FIG. 9 may be applied to electronic control devices of various electronic apparatuses. FIG. 10 is a diagram illustrating an example in which the electronic system of FIG. 9 is applied to a smart phone. In this way, if the electronic system 900 of FIG. 9 is applied to a smart phone 1000, the electronic system 900 of FIG. 9 may be, e.g., an application processor (AP) system.

In addition, the electronic system 900 of FIG. 9 may be provided as one of various components of an electronic device such as a computer, a ultra mobile personal computer (UMPC), a workstation, a net-book, a personal digital assistant (PDA), a portable computer (PC), a web tablet, a wireless phone, a mobile phone, a smart phone, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, a device for transmitting and receiving information in a wireless environment, one of various electronic devices constituting a home network, one of various electronic devices constituting a computer network, one of various electronic devices constituting a telematics network, a radio frequency identification (RFID) device, and one of various components constituting a computing system.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A memory system, comprising:
a central processing unit;
a memory management unit configured to receive a virtual address from the central processing unit and configured to convert the virtual address into a physical address;
a main memory configured to be accessed based on the physical address converted by the memory management unit and configured to store data used by the central processing unit, wherein the main memory includes a first area including a non-volatile memory and a second area including a volatile memory, wherein first file data having a first characteristic is included in the first area of the main memory, and second file data having a second characteristic different from the first characteristic is included in the second area of the main memory; and
a management table configured to manage the first area of the first and second areas of the main memory.

2. The memory system of claim 1, wherein the first characteristic includes a read-only characteristic, and the second characteristic includes a read-write characteristic.

3. The memory system of claim 1, wherein the first file data includes a code area, and the second file data includes a Block Started by Symbol (BSS) area and a data area.

4. The memory system of claim 1, wherein the management table includes a flag configured to determine whether the first file data included in the first area is valid data, and additional information configured to determine whether the first file data included in the first area is the same data as data stored in a storage.

5. The memory system of claim 4, wherein the additional information includes file information containing a file storage time and a file size, and a predetermined value calculated from the first file data.

6. The memory system of claim 1, wherein the management table is provided in a Transition Lookaside Buffer (TLB).

7. The memory system of claim 1, wherein the non-volatile memory includes a Magnetic Random Access Memory (MRAM), and the volatile memory includes a Dynamic Random Access Memory (DRAM).

8. The memory system of claim 1, wherein during an initial operation of the memory system, a predetermined number m (m is a natural number) of pieces of the first file data among n pieces (n is a natural number) of the first file data stored in a storage are included in the first area of the main memory.

9. The memory system of claim 1, wherein the management table is managed by an operating system which controls an operation of the memory system.

10. A method for operating a memory system, the method comprising:
providing a main memory, wherein the main memory includes a first area including a non-volatile memory and a second area including a volatile memory, wherein first file data having a first characteristic is included in the first area, and second file data having a second characteristic different from the first characteristic is included in the second area;
providing a management table, the management table configured to manages the first area in the first and second areas of the main memory; and
performing a page swap-out on the first file data by changing a predetermined flag included in the management table without deleting the first file data included in the first area, and performing the page swap-out on the second file data by deleting the second file data included in the second area.

11. The method of claim 10, further comprising performing a page swap-in on the first file data by changing the predetermined flag without loading the first file data into the first area using information included in the management table, and performing the page swap-in on the second file data by loading the second file data in the second area.

12. The method of claim 11, wherein using the information included in the management table comprises comparing file information on first file data included in the management table with file information on first file data stored in storage.

13. The method of claim 10, wherein the first characteristic includes a read-only characteristic, and the second characteristic includes a read-write characteristic.

14. The method of claim 10, wherein the first file data includes a code area, and the second file data includes a Block Started by Symbol (BSS) area and a data area.

15. The method of claim 10, wherein the non-volatile memory includes a Magnetic Random Access Memory (MRAM), and the volatile memory includes a Dynamic Random Access Memory (DRAM).

16. The method of claim 10, further comprising, during an initial operation of the memory system, loading, into the first area of the main memory, a predetermined number m (m is a natural number) of pieces of the first file data among n pieces (n is a natural number) of the first file data stored in a storage.

17. A memory device, comprising:
a first area in which first file data having a first characteristic is loaded; and
a second area in which second file data having a second characteristic different from the first characteristic is loaded, wherein the first area of the first and second areas is managed based on a management table,
wherein when the first file data and the second file data swap out a page to storage, the first file data remains in the first area of the memory device, and the second file data is deleted from the second area of the memory device.

18. The memory device of claim 17, wherein the first area of the memory device corresponds to a non-volatile memory, and the second area of the memory device corresponds to a volatile memory.

19. The memory device of claim 17, wherein during an initial operation of the memory device, a predetermined number of data is loaded from the storage into the first area of the main device.
